(19) United States
(12) Patent Application Publication
(10) Pub. No.: US 2026/0030034 A1
(43) Pub. Date: Jan. 29, 2026

(54) DYNAMICALLY CONFIGURE A SYSTEM ON CHIP FOR DIFFERENT HARDWARE CONFIGURATIONS FROM A SERIAL PERIPHERAL INTERFACE IMAGE USING AN EMBEDDED CONTROLLER

(71) Applicant: DELL PRODUCTS L.P., Round Rock, TX (US)

(72) Inventors: Balasingh Samuel, Round Rock, TX (US); Michael Arms, Copperas Cove, TX (US)

(21) Appl. No.: 18/782,883

(22) Filed: Jul. 24, 2024

(51) Int. Cl. G06F 9/4401; G06F 12/02; G06F 13/42

(52) U.S. Cl. CPC G06F 9/4411; G06F 12/023; G06F 13/4282

(57) ABSTRACT

An information handling system, comprising a memory and a processor to communicate with the memory. The processor is configured to determine whether a current boot process of the information handling system is a first boot process. If the current boot process is the first boot process, then determine whether a record in an SPI image is to be updated based on a lookup table. The processor is also configured to update the record in the SPI image based on data included in the lookup table. Subsequent to the update of the record, the processor is configured to proceed with execution of the current boot process of the information handling system.

### FIELD OF THE DISCLOSURE

The present disclosure generally relates to information handling systems, and more particularly relates to a system and method to dynamically configure a system on chip for different hardware configurations from a serial peripheral interface image using an information handling system's embedded controller.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system, comprising a memory and a processor to communicate with the memory. The processor is configured to determine whether a current boot process of the information handling system is a first boot process. If the current boot process is the first boot process, then determine whether a record in a serial peripheral interface (SPI) image is to be updated based on a lookup table. The processor is also configured to update the record in the SPI image based on data included in the lookup table. Subsequent to the update of the record, the processor is configured to proceed with execution of the current boot process of the information handling system.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of an information handling system for dynamically configuring the system-on-chip (SoC) for different hardware configurations from an SPI image using an information handling system's embedded controller, according to an embodiment of the present disclosure;

FIG. 2 is a flowchart of a method for dynamically configuring the SoC for different hardware configurations from an SPI image using an information handling system's embedded controller, according to an embodiment of the present disclosure;

FIG. 3 is a diagram of a dynamic hardware information table, according to an embodiment of the present disclosure;

FIG. 4 is a diagram of a data structure, which includes data values of a column data of a dynamic hardware information table, according to an embodiment of the present disclosure;

FIGS. 5, 6, and 7 are diagrams of SoC flash descriptor records of an information handling system, according to an embodiment of the present disclosure;

FIG. 8 is a diagram of an update process of one or more records of SoC flash descriptor records, according to an embodiment of the present disclosure;

FIG. 9 is a diagram of a process flow for dynamically configuring the SoC for different hardware configurations from an SPI image using an information handling system's embedded controller, according to an embodiment of the present disclosure; and

FIG. 10 is a block diagram of an information handling system, according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Typically, it is not possible to share an SPI image between multiple models of an information handling system. One of the reasons is that platform and hardware-specific chipset settings are statically defined during a build process. These chipset settings are related to differentiating characteristics between system models. For example, when one system model has four Universal Serial Bus (USB) ports and another model has two USB ports, typically these two system models cannot share one SPI image. Other examples of hardware-specific chipset settings include USB port mapping, bus tuning, Peripheral Component Interface (PCI) root port bifurcation, etc.

Accordingly, developing, validating, maintaining, and delivering basic input/output system (BIOS) releases are performed separately for each system model, duplicating work for developers which increases cost. For example, when a bug fix is applied to one platform, the bug fix may have to be validated in other platforms. This delays the delivery of the bug fix. Thus, to address these and other issues, it would be desirable to have one SPI image that applies to different platforms or system models, as provided by the present disclosure.

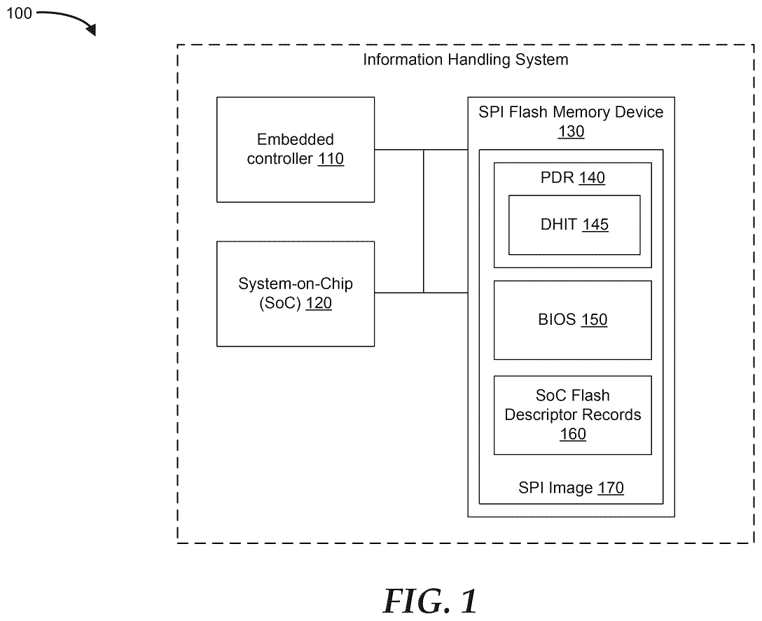

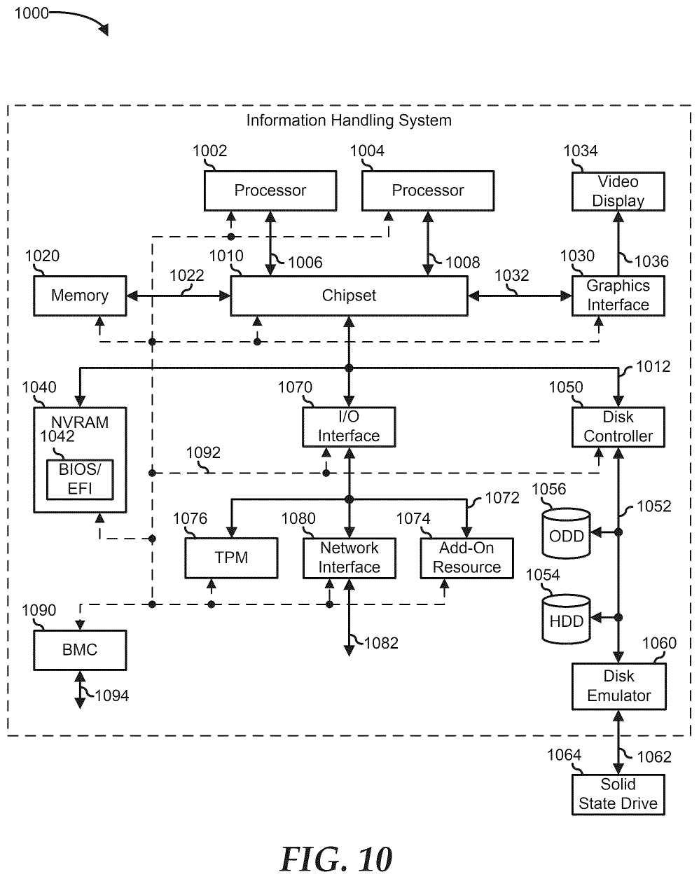

FIG. 1 illustrates a portion of an information handling system 100 for dynamically configuring the system on chip for different hardware configurations from an SPI image using an information handling system's embedded controller, according to an embodiment of the present disclosure. Information handling system 100, which is similar to information handling system 1000 of FIG. 10, includes an embedded controller 110, an SoC 120, and a SPI flash memory device 130. SPI flash memory device 130 includes an SPI image 170 which further includes a platform data region (PDR) 140, a BIOS 150, and an SoC flash descriptor records 160. PDR 140 includes a dynamic hardware information table (DHIT) 145. SPI flash memory device 130 may be connected to embedded controller 110, and SoC 120. However, any variety of connections between SPI flash memory device 130, embedded controller 110, and SoC 120 are envisioned as falling within the scope of the present disclosure. In addition, connections between components may be omitted for descriptive clarity. The operations described herein as being performed by one or more components of information handling system 100, such as embedded controller 110 may be executed by a processor, similar to processors 1002 and 1004 of FIG. 10.

Information handling systems are configured with one or more central processing units (CPUs) and a chipset device or SoC for coupling the CPUs to various peripheral devices and busses. In some information handling systems, chipset features are configured through a statically generated formatted configuration file, which is consumed by the BIOS once, at build time. The chipset features configured in this manner may define, as examples, a configuration of peripheral busses including USB power delivery controllers. The chipset settings may indicate, for example, USB connector type, USB port speed, USB port pairing, power delivery re-timer options, and other settings. The configured file is stored in a non-volatile storage device in a region called a SoC flash descriptor region. The configured file may be referred to as SoC flash descriptor records.

Information handling system 100 may be configured to provide generic support for sharing a single SPI image among multiple platforms with similar or compatible SoC or a silicon generation stock-keeping unit (SKU) by leveraging the system's embedded controller to dynamically modify platform-specific SPI-based configuration settings in the SoC flash descriptor records on a first boot of the information handling system. The first boot typically occurs after programming the SPI image prior to bringing the SoC out of a reset mode for the first time, which is before the SoC executes any code or instruction. In some instances, the embedded controller may also modify the configuration settings in a factory setting at first boot subsequent to a repair of the information handling system by a service technician.

SoC 120, which is similar to chipset 1010 of FIG. 10, may be configured to provide interconnects between a CPU and various components of information handling system 100 including a non-volatile memory express, embedded controller 110, and a SPI flash memory device 130. For example, while chipsets are usually comprised of one to four chips and feature a controller for commonly used peripherals, like a USB subsystem, SoC 120 may integrate several of the features of the chipset into a single silicon chip. For example, in addition to a processor, SoC may include a graphics processing unit (GPU), memory, and USB controller. As such, SoC 120 may control data paths connecting SoC 120 to other components or information handling system 100.

SPI flash memory device 130, which is similar to NVRAM 1040 of FIG. 10, is a shared flash memory device, which is connected to SoC 120 and embedded controller 110. SPI flash memory device 130 is configured to hold BIOS 150 and other platform-specific data, such as chipset configuration settings of one or more hardware components or devices. BIOS 150, which is similar to a basic input and output system/extensible firmware interface (BIOS/EFI) 1042 of FIG. 10, may be configured to retrieve chipset configuration settings from SoC flash descriptor records 160. In an embodiment, BIOS 150 can be substantially compliant with one or more revisions of the Unified Extensible Firmware Interface (UEFI) specification. As used herein, the term Extensible Firmware Interface (EFI) is used synonymously with the term UEFI.

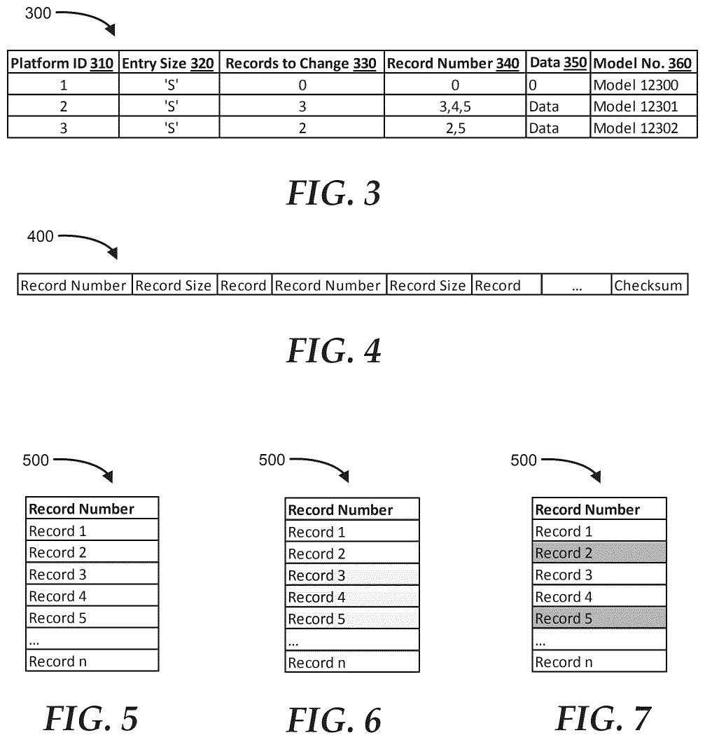

PDR 140 may be enabled to store user-specific data. For example, PDR 140 may be configured to store DHIT 145, which is similar to DHIT 300 of FIG. 3. DHIT 145 may include information for embedded controller 110 to modify or override chipset configuration settings stored in SoC flash descriptor records 160. SoC flash descriptor records 160 may be a data structure that includes factory-set settings for configuring one or more settings of various hardware components or devices supported by SoC 120. SoC flash descriptor records 160 may also include information associated with the configuration settings, such as size and permission. SoC flash descriptor records 160 can also include other data to be used by the hardware components or devices during initialization. SoC flash descriptor records 160 may be stored in one region of SPI flash memory device 130.

Embedded controller 110, which is similar to BMC 1090 of FIG. 10, is coupled to SoC 120 and may be configured to perform functions, such as power/thermal system management, etc. Embedded controller 110 may also be configured to perform other functions. For example, when power is first applied to the information handling system, embedded controller 110 may perform a sequence of operations. During this sequence of operations, embedded controller 110 may determine whether to update one or more records in SoC flash descriptor records 160 and perform the update according to information in DHIT 145. Embedded controller 110 may include a processing device for executing program instructions to perform the above-stated functions. Although not limited to such, a processing device of embedded controller 110 may be implemented as a programmable integrated circuit, such as a controller, microcontroller, microprocessor, etc., or as a programmable logic device, such as a Field Programmable Gate Array (FPGA), a complex programmable logic device, etc. Embedded controller 110 can be referred to as a service processor.

Those of ordinary skill in the art will appreciate that the configuration, hardware, and/or software components of information handling system 100 may vary. For example, the illustrative components within information handling system 100 are not intended to be exhaustive but rather are representative to highlight components that can be utilized to implement aspects of the present disclosure. For example, other devices and/or components may be used in addition to or in place of the devices/components depicted. The depicted example does not convey or imply any architectural or other limitations with respect to the presently described embodiments and/or the general disclosure. In the discussion of the figures, reference may also be made to components illustrated in other figures for continuity of the description.

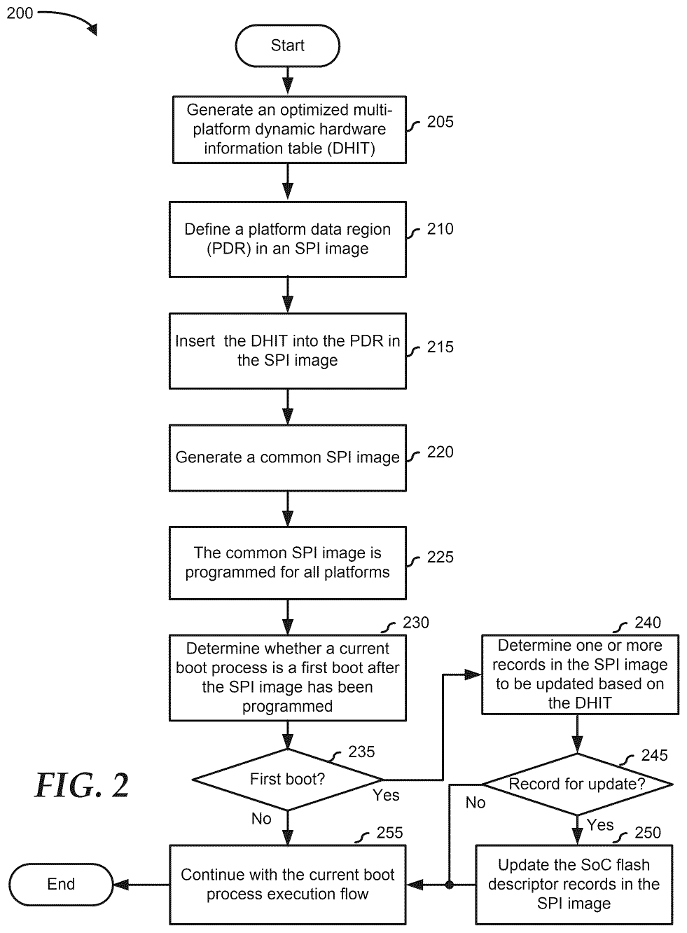

FIG. 2 illustrates a flowchart of a method 200 for different hardware configurations from an SPI image using an information handling system's embedded controller, according to an embodiment of the present disclosure. Method 200 may be performed by any suitable component of information handling system 100 including, but not limited to, embedded controller 110 of FIG. 1. While embodiments of the present disclosure are described in terms of the components of information handling system 100 of FIG. 1, it should be recognized that other components may be utilized to perform the described method. One of skill in the art will appreciate that this flowchart explains a typical example, which can be extended to applications or services in practice. It will be readily appreciated that not every method step outlined in this flowchart is always necessary and that certain steps of the methods may be combined, performed simultaneously, in a different order, or perhaps omitted, without varying from the scope of the disclosure.

Method 200 typically starts at block 205, where an optimized multi-platform DHIT, similar to a DHIT 300 may be generated. The DHIT may provide information for the embedded controller to dynamically reconfigure SoC configuration settings to support the platform's hardware. The DHIT table includes configuration override information for multiple platforms that consume a common SPI image. A common SPI image may be generated for platforms that have the same or similar SoC silicon generation. In addition to the DHIT, the SPI image may include a BIOS image and SoC flash descriptor records. Each entry in the DHIT may contain information that allows the embedded controller to perform an override of records that include chipset configuration settings in the SoC flash descriptor records. In one example, each entry in the DHIT may include a record type, platform identifier, SPI destination or location, override value, etc. Block 205 may be performed during system assembly at a factory or later in the field by the end-user or a repair technician.

At block 210, a PDR for the SPI image may be defined. Afterwards, at block 215, the DHIT may be inserted into the PDR of the SPI image where the DHIT can be located and/or consumed by the embedded controller or BIOS. At block 220, a common SPI image which includes the BIOS that supports hardware of multiple platforms or system models in a particular group is generated by a build server. A base platform's SoC flash descriptor records among others are used to generate the common SPI image. The base platform, also referred to as a base system model or base system platform, may be chosen based on one or more factors, such as the platform with the most number of features that are common with other platforms in a group, wherein the platforms have the same or similar generation of SoC silicon. This may result in a least number of differences with the other system platforms. Accordingly, one build job can be performed by the build server for the different platforms or system models per group. At block 225, the common SPI image may be programmed by the build server into the SPI flash memory device of the base platform and each one of the other platforms in the group.

At block 230, the embedded controller may determine whether a current boot process of the information handling system is its first boot after the SPI image has been programmed. For example, the BIOS may check a state flag that identifies whether the current boot process is the first boot process of the information handling system. For example, if the state flag is set to true, then the current boot process is the first boot process of the information handling system. Otherwise, if the state flag is set to false, then the current boot process is not the first boot process of the information handling system. The state flag may be set to true by default at the factory before the boot process. At decision block 235, if the current boot process is the first boot process, then the “YES” branch is taken, and the method proceeds to block 240. If the current boot process is not the first boot process, then the “NO” branch is taken, and the method proceeds to block 255.

At block 240, the embedded controller may determine whether the SoC flash descriptor records have one or more entries or records to be updated based on the DHIT. The embedded controller may determine the information handling system's platform's identifier by reading a general purpose input/output (GPIO) truth table. Based on the platform identifier, the embedded controller may determine the number of records to change, and which records to change if any. Typically, a base platform does not have any records to be changed as depicted by an entry associated with platform identifier 1 in DHIT 300 of FIG. 3. In another example, an information handling system of platform identifier 2 may have records 3, 4, and 5 to be updated in the SoC flash descriptor records as depicted in DHIT 300 of FIG. 3.

At decision block 245, if there is a record to be updated, then the “YES” branch is taken, and the method proceeds to block 250. If there is no record to be updated, then the “NO” branch is taken, and the method proceeds to block 255. At block 250, the embedded controller may update the SoC flash descriptor records based on block 240. The embedded controller may choose one or more records in the SoC flash descriptor records, also referred to as soft straps, to be updated according to the records identified as depicted in FIGS. 5 and 6, resulting in the SoC flash descriptor records depicted in FIG. 7. In addition, the embedded controller may set the state flag to false. At block 255, the BIOS continues with the execution flow of the current boot process.

FIG. 3 illustrates a portion of DHIT 300, according to an embodiment of the present disclosure. DHIT 300 includes several columns, such as a platform identifier 310, an entry size 320, a records to change 330, a record number 340, a data 350, and a model number 360. DHIT 300 includes a DHIT entry for each data row associated with a system model. As discussed, columns platform identifier 310 and/or model number 360 may be used to identify how many records are to be changed in SoC flash descriptor records, such as depicted in FIG. 5. In addition, column record number 340 identifies the record numbers or identifiers of the records to be changed. Data 350 includes configuration settings and other values for the records to be changed, such as depicted in a data structure 400 of FIG. 4. DHIT 300 may be a lookup table that is stored in a PDR of the SPI flash memory device.

In one example, a set of SoC flash descriptor records may not have an entry or record to be updated if the information handling system is the base platform, such as depicted in an entry associated with platform identifier 1 as depicted in DHIT 300. Accordingly, a set of SoC flash descriptor records may have an entry or record to be updated if the information handling system is not the base platform, such as entries associated with platform identifiers 2 and 3 as depicted in DHIT 300. Accordingly, system platforms, also referred to herein simply as platforms, with platform identifiers 2 and 3 may belong to a group of platforms with the base platform of platform identifier 1. As such, Model 12300 may be a base system model, while Models 12301 and 12302 are sub-system models related to the base system model.

FIG. 4 illustrates data structure 400, which includes values of column data 350 of DHIT 300 of FIG. 3. Data structure 400 may have an entry for each record to be changed. Each entry may include a data value for a record number, a record size, and record data. The record number column is a record identifier while a record size indicates how many bytes of the data value in the record data. In one example, because there is no record to be updated for platform identifier “1,” there may not be an entry associated with platform identifier 1. For platform identifier 2, there may be three entries in data structure 400 because there are three records to be changed or overridden, which are records 3, 4, and 5 as depicted in record number 340 of FIG. 3. Similarly, for platform identifier 3, there may be two entries in data structure 400 because there are two records to change, which are records 2 and 5 as depicted in record number 340 of FIG. 3. In this example, data structure 400 is shown as a list, however, one of skill in the art will appreciate that other types of data structures may be used, such as an array or a queue, among others may be used.

FIGS. 5, 6, and 7 illustrate a portion of SoC flash descriptor records 500 of an information handling system, according to an embodiment of the present disclosure. In this example, the information handling system is a base model for a particular silicon generation, such as Model 12300. SoC flash descriptor records 500 includes a plurality of records with factory-set settings for configuring one or more of the various I/O interfaces supported by the chipset of the information handling system. SoC flash descriptor records 500 may be included in an SPI image which is stored in an SPI flash memory device, such as SPI flash memory device 130 of FIG. 1.

FIG. 6 illustrates a portion of SoC flash descriptor records 500 for an information handling system, wherein records 3, 4, and 5 are highlighted to show differences between the SoC flash descriptor records 500, which is of a base platform, and SoC flash descriptor records of another system platform. In this example, the model number of the information handling system is Model 12301, which is part of a group of platforms that includes the base model, Model 12300. Records 3, 4, and 5 are updated because these records are different compared to records 3, 4, and 5 of the base platform.

FIG. 7 illustrates a portion of SoC flash descriptor records 500 for an information handling system, wherein records 2 and 5 are highlighted to show differences between the SoC flash descriptor records 500, which is of a base platform, and the SoC flash descriptor records of another system platform. In this example, the model number of the information handling system is Model 12302, which is part of a group of platforms that includes the base model, Model 12300. Records 2 and 5 are updated because these records are different compared to records 2 and 5 of the base model.

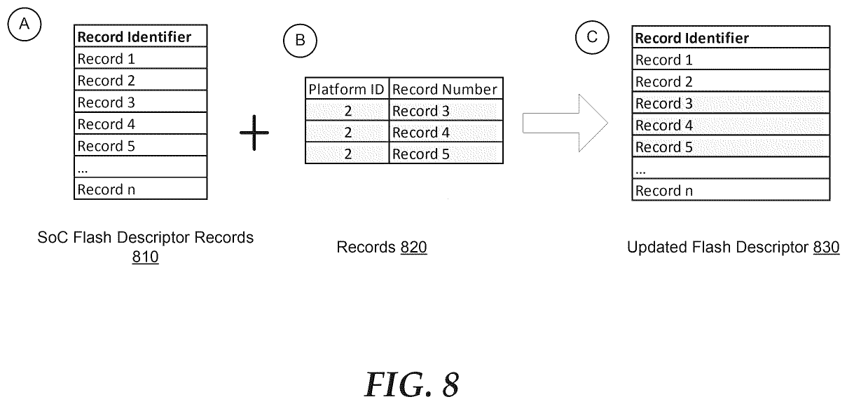

FIG. 8 illustrates an update process of one or more records of a SoC flash descriptor records 810, which is similar to SoC flash descriptor records 500 of FIG. 5. FIG. 8 also includes records 820, and updated SoC flash descriptor records 820. FIG. 8 is annotated with a series of letters A-C. Each of these numbers represents a stage of one or more operations. Although these stages are ordered for this example, the stages illustrate one example to aid in understanding this disclosure and should not be used to limit the claims. Subject matter falling within the scope of the claims can vary with respect to the order of the operations.

At stage A, SoC flash descriptor records 810 may be stored in a region of an SPI flash memory device. SoC flash descriptor records 810 may include records of various configuration settings of a base platform or information handling system. At stage B, during the first boot of the information handling system, an embedded controller may determine records to be updated based on its platform identifier, such as records 820. In this example, because the information handling system has a platform identifier of 2, records 3, 4, and 5 are to be updated by the embedded controller based on DHIT 300 of FIG. 3. At stage C, the embedded controller may update records 3, 4, and 5 of SoC flash descriptor records 810 with records 820 resulting in updated SoC flash descriptor records 830. One of skill in the art will appreciate that this process explains a typical example, which can be extended to applications or services in practice.

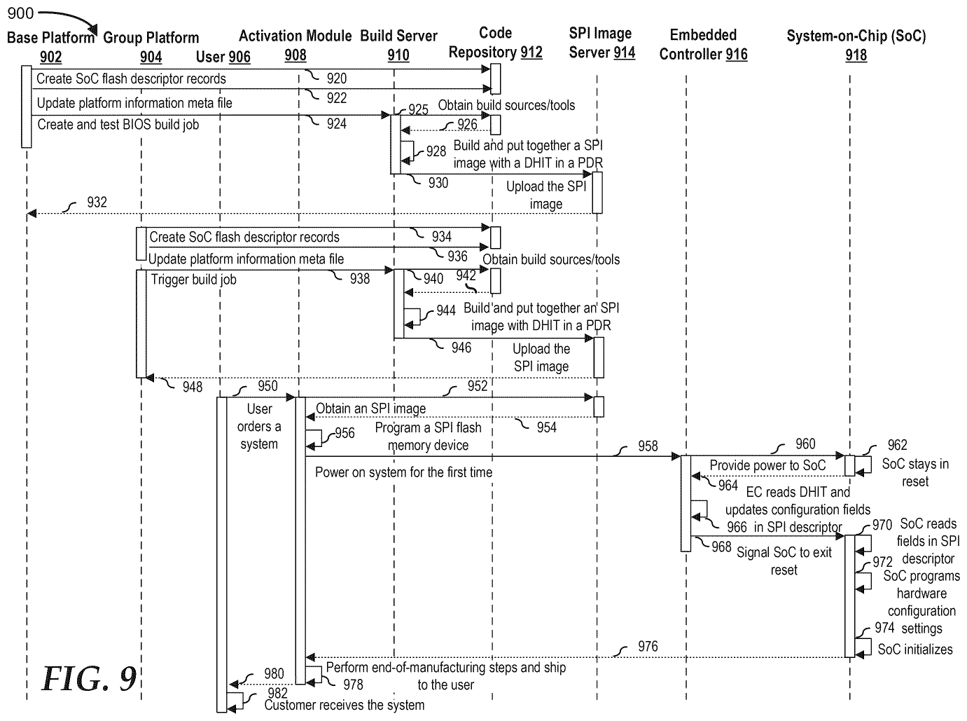

FIG. 9 illustrates a process flow 900, according to an embodiment of the present disclosure. Process flow 900 includes one or more operations that may be performed by various components including but not limited to a base platform 902, a group platform 904, a user 906, an activation module 908, a build server 910, a code repository 912, a SPI image server 914, an embedded controller 916, and a SoC 918. Base platform 902 may be an information handling system that is similar to information handling system 100 of FIG. 1. Group platform 904 includes at least two information handling system platforms, wherein one of the information handling system platforms is a base platform, such as base platform 902.

Activation module 908 may be included in one of the information handling systems in group platform 904 which is executed when the information handling system is assembled at a factory. Build server 910 may be used to build a BIOS and/or SPI image in the factory. Code repository 912 may be used to store build sources, and tools among others at the factory. SPI image server 914 may be used to store a BIOS image, SPI image, a DHIT, SPI flash descriptor records, etc. Embedded controller 916, which is similar to embedded controller 110 of FIG. 1, may be configured to initiate a power supply to provide power to the information handling system.

Embedded controller 916 may also be configured to update records in SPI flash descriptor records as appropriate. SoC 918, which is similar to SoC 120 of FIG. 1, may be configured to program hardware configuration settings of hardware components and/or devices of the information handling system. While embodiments of the present disclosure are described in terms of the above, it should be recognized that other components and/or devices may be utilized to perform the described method. One of skill in the art will appreciate that this process flow diagram explains a typical example, which can be extended to applications or services in practice. In addition, it will be readily appreciated that not every operation step set forth in this process flow diagram is always necessary and that certain operations may be combined, performed simultaneously, in a different order, or perhaps omitted, without varying from the scope of the disclosure.

Process flow 900 typically starts at operation 920 where base platform 902 may be used to create or generate SoC flash descriptor records, such as SoC flash descriptor records 810. The SoC flash descriptor records may be generated based on configuration settings associated with base platform 902. The SoC flash descriptor records may be transmitted to code repository 912 for storage. The SoC flash descriptor records may be used for an SPI image common to a group of platforms, such as group platform 904. At operation 922, base platform 902 may be used to update a platform information metadata file. The platform information metadata file may also be transmitted to code repository 912 for storage. At operation 924, the base platform may be used to create and test a BIOS build job. A request that includes the BIOS build job may be transmitted to build server 910. At operation 925, build server 910 may transmit a request to obtain build sources and/or tools to code repository 912.

At operation 926, code repository 912 may transmit build sources and/or tools to build server 910 in response to the request associated with operation 925. The build sources and/or tools transmitted may include the SoC flash descriptor records and the updated platform information metadata file. At block 928, build server 910 may build and assemble an SPI image with a DHIT in a PDR of the SPI image. The SPI image may also include the BIOS. At operation 930, build server 910 may upload the SPI image to SPI image server 914. After receiving the SPI image, SPI image server 914 may transmit a response 932 to the request associated with operation 924. The response may include the SPI image.

At operation 934, an information handling system included in group platform 904 may be used to create SoC flash descriptor records similar to operation 920. However, these SoC flash descriptor records may be particular to components and/or devices of a platform belonging to group platform 904. In one example, the platform may be part of a group of platforms for CPU/SoC silicon generation. In addition, base platform 902 may also be part of group platform 904. At operation 936, the information handling system in group platform 904 may be used to update a platform information metadata file. The platform information metadata file may also be transmitted to code repository 912 for storage. At operation 938, the information handling system of group platform 904 may be used to trigger a BIOS build job. A request to trigger the BIOS build job may be transmitted to build server 910.

At operation 940, build server 910 may transmit a request to obtain build sources and/or tools to code repository 912. At operation 942, code repository 912 may transmit a response to the request at operation 940. The response may include the SoC flash descriptor records and the platform information metafile. At operation 944, build server 910 may build and put together an SPI image with DHIT in a PDR of an SPI flash memory device. At operation 946, build server 910 may upload the SPI image to SPI image server 914. At operation 948, SPI image server 914 may transmit a response to group platform 904. The response may include the SPI image in response to the request at operation 938.

At operation 950, user 906 may transmit an order of an information handling system to an activation module 908. Activation module 908 may be used to activate the information handling system upon receipt by user 906. At operation 952, activation module 908 may transmit a request to obtain an SPI image from SPI image server 914. At operation 954, SPI image server 914 may transmit a response to the request at operation 952 with the SPI image. At operation 956, upon receipt of the SPI image, activation module 908 may program an SPI flash memory device of the information handling system with the received SPI image. At operation 958, activation module 908 may transmit a request to provide power and turn on the information handling system for the first time to embedded controller 916.

At operation 960, embedded controller 916 may provide power on SoC 918. For example, embedded controller 916 may transmit a signal to a power supply to provide power to SoC 918. At operation 962, SoC 918 may be powered on and stay in reset mode. At operation 964, SoC 918 may transmit a response to embedded controller 916 regarding its power status. At operation 966, embedded controller 916 may read the DHIT and update the configuration settings in a field descriptor of the SPI flash memory device. Prior to performing operation 966, the embedded controller may check a state flag to determine whether the current boot process is the first boot process of the information handling system.

At operation 968, embedded controller 916 may transmit a signal to SoC 918 to exit the reset mode. In addition, embedded controller 916 may set the state flag to false. At operation 970, upon receipt of the signal, SoC 918 may read records in SoC field descriptor records in the SPI image. At operation 972, SoC 918 may program hardware configuration settings based on the configuration settings in the SoC field descriptor records. At operation 974, SoC 918 may initialize one or more hardware components and/or devices based on the configuration settings. At operation 976, SoC 918 may transmit a response to activation module 908 for the power on request at operation 958. At operation 978, activation module 908 may perform end-of-manufacturing steps and ship the information handling system to user 906. At operation 980, the information handling system may be in transit until user 906 receives the information handling system at operation 982.

FIG. 10 illustrates an embodiment of an information handling system 1000 including processors 1002 and 1004, a chipset 1010, a memory 1020, a graphics adapter 1030 connected to a video display 1034, a non-volatile RAM (NVRAM) 1040 that includes BIOS/EFI module 1042, a disk controller 1050, a hard disk drive (HDD) 1054, an optical disk drive (ODD) 1056, a disk emulator 1060 connected to a solid-state drive (SSD) 1064, an input/output (I/O) interface 1070 connected to an add-on resource 1074 and a trusted platform module (TPM) 1076, a network interface 1080, and a baseboard management controller (BMC) 1090. Processor 1002 is connected to chipset 1010 via processor interface 1006, and processor 1004 is connected to the chipset via processor interface 1008.

In a particular embodiment, processors 1002 and 1004 are connected via a high-capacity coherent fabric, such as a HyperTransport link, a QuickPath Interconnect, or the like. Chipset 1010 represents an integrated circuit or group of integrated circuits that manage the data flow between processors 1002 and 1004 and the other elements of information handling system 1000. In a particular embodiment, chipset 1010 represents a pair of integrated circuits, such as a northbridge component and a southbridge component. In another embodiment, some or all of the functions and features of chipset 1010 are integrated with one or more processors 1002 and 1004.

Memory 1020 is connected to chipset 1010 via a memory interface 1022. An example of memory interface 1022 includes a Double Data Rate (DDR) memory channel and memory 1020 represents one or more DDR Dual In-Line Memory Modules (DIMMs). In a particular embodiment, memory interface 1022 represents two or more DDR channels. In another embodiment, one or more of processors 1002 and 1004 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 1020 may further represent various combinations of memory types, such as Dynamic Random Access Memory (DRAM) DIMMs, Static Random Access Memory (SRAM) DIMMs, non-volatile DIMMs (NV-DIMMs), storage class memory devices, Read-Only Memory (ROM) devices, or the like. Graphics adapter 1030 is connected to chipset 1010 via a graphics interface 1032 and provides a video display output 1036 to a video display 1034. An example of a graphics interface 1032 includes a Peripheral Component Interconnect-Express (PCIe) interface and graphics adapter 1030 can include a four-lane (×4) PCIe adapter, an eight-lane (×8) PCIe adapter, a 16-lane (×16) PCIe adapter, or another configuration, as needed or desired. In a particular embodiment, graphics adapter 1030 is provided down on a system printed circuit board (PCB). Video display output 1036 can include a Digital Video Interface (DVI), a High-Definition Multimedia Interface (HDMI), a DisplayPort interface, or the like, and video display 1034 can include a monitor, a smart television, an embedded display such as a laptop computer display, or the like.

NVRAM 1040, disk controller 1050, and I/O interface 1070 are connected to chipset 1010 via an I/O channel 1012. An example of I/O channel 1012 includes one or more point-to-point PCIe links between chipset 1010 and each of NVRAM 1040, disk controller 1050, and I/O interface 1070. Chipset 1010 can also include one or more other I/O interfaces, including a PCIe interface, an Industry Standard Architecture (ISA) interface, a Small Computer Serial Interface (SCSI) interface, an Inter-Integrated Circuit (I²C) interface, a System Packet Interface, a USB, another interface, or a combination thereof. NVRAM 1040 includes BIOS/EFI module 1042 that stores machine-executable code (BIOS/EFI code) that operates to detect the resources of information handling system 1000, to provide drivers for the resources, to initialize the resources, and to provide common access mechanisms for the resources. The functions and features of BIOS/EFI module 1042 will be further described below.

Disk controller 1050 includes a disk interface 1052 that connects the disc controller to a hard disk drive (HDD) 1054, to ODD 1056, and to disk emulator 1060. An example of disk interface 1052 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 1060 permits SSD 1064 to be connected to information handling system 1000 via an external interface 1062. An example of external interface 1062 includes a USB interface, an institute of electrical and electronics engineers (IEEE) 1394 (Firewire) interface, a proprietary interface, or a combination thereof. Alternatively, SSD 1064 can be disposed within information handling system 1000.

I/O interface 1070 includes a peripheral interface 1072 that connects the I/O interface to add-on resource 1074, to TPM 1076, and to network interface 1080. Peripheral interface 1072 can be the same type of interface as I/O channel 1012 or can be a different type of interface. As such, I/O interface 1070 extends the capacity of I/O channel 1012 when peripheral interface 1072 and the I/O channel are of the same type, and the I/O interface translates information from a format suitable to the I/O channel to a format suitable to the peripheral interface 1072 when they are of a different type. Add-on resource 1074 can include a data storage system, an additional graphics interface, a network interface card (NIC), a sound/video processing card, another add-on resource, or a combination thereof. Add-on resource 1074 can be on a main circuit board, on a separate circuit board, or add-in card disposed within information handling system 1000, a device that is external to the information handling system, or a combination thereof.

Network interface 1080 represents a network communication device disposed within information handling system 1000, on a main circuit board of the information handling system, integrated onto another component such as chipset 1010, in another suitable location, or a combination thereof. Network interface 1080 includes a network channel 1082 that provides an interface to devices that are external to information handling system 1000. In a particular embodiment, network channel 1082 is of a different type than peripheral interface 1072 and network interface 1080 translates information from a format suitable to the peripheral channel to a format suitable to external devices.

In a particular embodiment, network interface 1080 includes a NIC or host bus adapter (HBA), and an example of network channel 1082 includes an InfiniBand channel, a Fibre Channel, a Gigabit Ethernet channel, a proprietary channel architecture, or a combination thereof. In another embodiment, network interface 1080 includes a wireless communication interface, and network channel 1082 includes a Wi-Fi channel, a near-field communication (NFC) channel, a Bluetooth® or Bluetooth-Low-Energy (BLE) channel, a cellular-based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 1082 can be connected to an external network resource (not illustrated). The network resource can include another information handling system, a data storage system, another network, a grid management system, another suitable resource, or a combination thereof.

BMC 1090 is connected to multiple elements of information handling system 1000 via one or more management interface 1092 to provide out-of-band monitoring, maintenance, and control of the elements of the information handling system. As such, BMC 1090 represents a processing device different from processor 1002 and processor 1004, which provides various management functions for information handling system 1000. For example, BMC 1090 may be responsible for power management, cooling management, and the like. The term BMC is often used in the context of server systems, while in a consumer-level device, a BMC may be referred to as an EC. A BMC included in a data storage system can be referred to as a storage enclosure processor. A BMC included at a chassis of a blade server can be referred to as a chassis management controller and embedded controllers included at the blades of the blade server can be referred to as blade management controllers. Capabilities and functions provided by BMC 1090 can vary considerably based on the type of information handling system. BMC 1090 can operate in accordance with an Intelligent Platform Management Interface (IPMI). Examples of BMC 1090 include an Integrated Dell® Remote Access Controller (iDRAC).

Management interface 1092 represents one or more out-of-band communication interfaces between BMC 1090 and the elements of information handling system 1000 and can include an Inter-Integrated Circuit (I2C) bus, a System Management Bus (SMBus), a Power Management Bus (PMBUS), a Low Pin Count (LPC) interface, a serial bus such as a USB or an SPI, a network interface such as an Ethernet interface, a high-speed serial data link such as a PCIe interface, a Network Controller Sideband Interface (NC-SI), or the like. As used herein, out-of-band access refers to operations performed apart from a BIOS/operating system execution environment on information handling system 1000, that is apart from the execution of code by processors 1002 and 1004 and procedures that are implemented on the information handling system in response to the executed code.

BMC 1090 operates to monitor and maintain system firmware, such as code stored in BIOS/EFI module 1042, option ROMs for graphics adapter 1030, disk controller 1050, add-on resource 1074, network interface 1080, or other elements of information handling system 1000, as needed or desired. In particular, BMC 1090 includes a network interface 1094 that can be connected to a remote management system to receive firmware updates, as needed or desired. Here, BMC 1090 receives firmware updates, stores the updates to a data storage device associated with the BMC, and transfers the firmware updates to the NVRAM of the device or system that is the subject of the firmware update, thereby replacing the currently operating firmware associated with the device or system, and reboots information handling system, whereupon the device or system utilizes the updated firmware image.

BMC 1090 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 1090, an interface defined by the Distributed Management Taskforce (DMTF) (such as a Web Services Management (WSMan) interface, a Management Component Transport Protocol (MCTP) or, a Redfish® interface), various vendor-defined interfaces (such as a Dell EMC Remote Access Controller Administrator (RACADM) utility, a Dell EMC OpenManage Enterprise, a Dell EMC OpenManage Server Administrator (OMSA) utility, a Dell EMC OpenManage Storage Services (OMSS) utility, or a Dell EMC OpenManage Deployment Toolkit (DTK) suite), a BIOS setup utility such as invoked by a “F2” boot option, or another protocol or API, as needed or desired.

In a particular embodiment, BMC 1090 is included on a main circuit board (such as a baseboard, a motherboard, or any combination thereof) of information handling system 1000 or is integrated into another element of the information handling system such as chipset 1010, or another suitable element, as needed or desired. As such, BMC 1090 can be part of an integrated circuit or a chipset within information handling system 1000. An example of BMC 1090 includes an iDRAC or the like. BMC 1090 may operate on a separate power plane from other resources in information handling system 1000. Thus BMC 1090 can communicate with the management system via network interface 1094 while the resources of information handling system 1000 are powered off. Here, information can be sent from the management system to BMC 1090 and the information can be stored in a RAM or NVRAM associated with the BMC. Information stored in the RAM may be lost after the power-down of the power plane for BMC 1090, while information stored in the NVRAM may be saved through a power-down/power-up cycle of the power plane for the BMC.

Information handling system 1000 can include additional components and additional busses, not shown for clarity. For example, information handling system 1000 can include multiple processor cores, audio devices, and the like. While a particular arrangement of bus technologies and interconnections is illustrated for the purpose of example, one of skill will appreciate that the techniques disclosed herein are applicable to other system architectures. Information handling system 1000 can include multiple central processing units (CPUs) and redundant bus controllers. One or more components can be integrated together. Information handling system 1000 can include additional busses and bus protocols, for example, I²C and the like. Additional components of information handling system 1000 can include one or more storage devices that can store machine-executable code, one or more communications ports for communicating with external devices, and various input and output (I/O) devices, such as a keyboard, a mouse, and a video display.

For purposes of this disclosure information handling system 1000 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 1000 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 1000 can include processing resources for executing machine-executable code, such as processor 1002, a programmable logic array (PLA), an embedded device such as a System-on-a-Chip (SoC), or other control logic hardware. Information handling system 1000 can also include one or more computer-readable media for storing machine-executable code, such as software or data.

Although FIG. 2 shows example blocks of method 200 in some implementations, method 200 may include additional blocks, fewer blocks, different blocks, or differently arranged blocks than those depicted in FIG. 2. Those skilled in the art will understand that the principles presented herein may be implemented in any suitably arranged processing system. Additionally, or alternatively, two or more of the blocks of method 200 may be performed in parallel. For example, blocks 205 and 210 of method 200 may be performed in parallel.

Similarly, although FIG. 9 shows example operations associated with process flow 900 in some implementations, process flow 900 may include additional operations, fewer operations, or differently arranged operations than those depicted in FIG. 9. Those skilled in the art will understand that the principles presented herein may be implemented in any suitably arranged processing system. Additionally, or alternatively, two or more operations of process flow 900 may be performed in parallel. For example, operations 920 and 922 of process flow 900 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

When referred to as a “device,” a “module,” a “unit,” a “controller,” or the like, the embodiments described herein can be configured as hardware. For example, a portion of an information handling system device may be hardware such as, for example, an integrated circuit (such as an Application Specific Integrated Circuit (ASIC), an FPGA, a structured ASIC, or a device embedded on a larger chip), a card (such as a PCI card, a PCI-express card, a Personal Computer Memory Card International Association (PCMCIA) card, or other such expansion card), or a system (such as a motherboard, a system-on-a-chip (SoC), or a stand-alone device).

The present disclosure contemplates a non-transitory computer-readable medium that includes instructions or receives and executes instructions responsive to a propagated signal; so that a device connected to a network can communicate voice, video, or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that causes a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes, or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

What is claimed is:

1. A method comprising:
determining, by a processor, whether a current boot process of an information handling system is a first boot process;
when the current boot process is the first boot process, determining whether a record in a serial peripheral interface (SPI) image is to be updated based on a lookup table;
updating the record in the SPI image based on data values included in the lookup table; and
subsequent to the updating of the record, proceeding with executing the current boot process of the information handling system.

2. The method of claim 1, wherein the record is a chipset configuration setting.

3. The method of claim 1, wherein the record is stored in a region of an SPI flash memory device.

4. The method of claim 1, wherein the lookup table is stored in a platform data region of an SPI flash memory device.

5. The method of claim 1, wherein the SPI image is common between at least two system platforms.

6. The method of claim 1, wherein the updating of the record is performed by an embedded controller.

7. The method of claim 1, wherein the lookup table is generated based on configuration settings of a base system platform.

8. The method of claim 1, wherein the SPI image is generated based on a base system platform.

9. An information handling system, comprising:
a memory; and
a processor to communicate with the memory, the processor configured to:
determine whether a current boot process of the information handling system is a first boot process;
when the current boot process is the first boot process, determine whether a record in a serial peripheral interface (SPI) image is to be updated based on a lookup table;
update the record in the SPI image based on data included in the lookup table; and
subsequent to the update of the record, proceed with execution of the current boot process of the information handling system.

10. The information handling system of claim 9, wherein the record is a chipset configuration setting.

11. The information handling system of claim 9, wherein the record is stored in a region of an SPI flash memory device.

12. The information handling system of claim 9, wherein the lookup table is stored in a platform data region of an SPI flash memory device.

13. The information handling system of claim 9, wherein the SPI image is common between at least two system platforms.

14. The information handling system of claim 9, wherein the update of the record is performed by an embedded controller.

15. The information handling system of claim 9, wherein the lookup table is generated based on configuration settings of a base system platform.

16. The information handling system of claim 9, wherein the SPI image is generated based on a base system platform.

17. A non-transitory computer-readable medium to store instructions that are executable to perform operations comprising:
determining whether a current boot process of an information handling system is a first boot process;
when the current boot process is the first boot process, determining whether a record in a serial peripheral interface (SPI) image is to be updated based on a lookup table;
updating the record in the SPI image based on data included in the lookup table; and
subsequent to the updating of the record, proceeding with executing the current boot process of the information handling system.

18. The non-transitory computer-readable medium of claim 17, wherein the record is a chipset configuration setting.

19. The non-transitory computer-readable medium of claim 17, wherein the record is stored in a region of an SPI flash memory device.

20. The non-transitory computer-readable medium of claim 17, wherein the lookup table is stored in a platform data region of an SPI flash memory device.
